(19) United States
(12) Patent Application Publication
(10) Pub. No.: US 2023/0025042 A1
(43) Pub. Date: Jan. 26, 2023

(54) A PRACTICE HORN

(71) Applicant: EMEO TEAM LTD., Be'er Sheva (IL)

(72) Inventors: Eddie GOFMAN, Beer Sheva (IL); Evgeny KLUKIN, Tel Aviv (IL)

(21) Appl. No.: 17/782,715

(22) PCT Filed: Dec. 8, 2020
(86) PCT No.: PCT/IL2020/051271

§ 371 Date: Jun. 6, 2022

Related U.S. Application Data
(60) Provisional application No. 62/945,172, filed on Dec. 8, 2019.

(51) Int. Cl. G10H 1/00; G10D 7/066; G10D 7/08

(52) U.S. Cl. CPC G10H 1/0066; G10D 7/066; G10D 7/08

(57) ABSTRACT

The present invention discloses a silent digital practice horn, useable with or without a mouthpiece, characterized by a processor and communicating means enabling wireless connection with DAW application via MIDI-USB or Bluetooth modules, and thereby connection with computers or smartphones, speakers or headphones thereof. The invention also discloses a digital practice shortened either Saxophone-like or Clarinet-like horn, wherein one or more of the following is held true: octave key is configured to change range; High E key (Eb-like horn) is configured to shift tonal range up; C key is configured to shift to normal tonal range; Bb key (Bb-like horn) is configured to shift tonal range down; at least one of the following, F key, E/F♯ key and D key is configured to facilitate or change MIDI Channel; Additional F♯ key is configured to power the horn Off; Eb/D3 Key and low C key, when pressed together, enters the processor to a “Command Mode”. The present invention further discloses a practice horn that comprises a siphon which causes saliva and moisture to run down a pipe inside the instrument and to drip out of a “Moisture Outlet” in a bottom cap located at the distal most portion of the horn.

### FIELD OF THE INVENTION

The invention generally pertains to a practice horn, and methods of operating the same.

### BACKGROUND OF THE INVENTION

US U.S. Pat. No. 5,214,231 discloses an apparatus for electronic teaching, accompaniment and practice of music, said apparatus being independent of a played musical instrument comprising a device for digital sound production; a device for tempo setting; a device for accompaniment; a device for operation; a device for input of digital note data; a control unit for connecting together each said device; an electro-acoustical device connected to said control unit for acoustical reproduction of note sequences corresponding to an input piece of music; a digital-analog converter for inputting said piece of music; a piano keyboard or a guitar fingerboard; an optical display device which is connected with said piano keyboard or said guitar fingerboard, for optical display of the note sequences played; and wherein the optical display device is structured as a reproduction of the operation or activation elements of the corresponding musical instrument, and is attached or plugged into the apparatus directly with plugs, or is set up at a remote location with cables. KR1020120126900 similarly discloses a sex phone in which muffler enabling to equip the mouth-piece of the sex phone as to the sex phone, infusing air with the mouth inside the musical instrument and causes sound and neck, or, the muffler among the neck and body are mounted. Much in the same way, KR101041254B1 discloses a saxophone training apparatus is provided to allow a user to practice vibrato without a saxophone using a mouth piece attached to a horn-shaped neck substitute. This saxophone training apparatus comprises a connection pipe and a sound pipe. The connection pipe has an outer diameter smaller than the inner diameter of a mouth piece to be inserted in the tip coupling part of the mouth piece. The sound pipe is extended from the connection pipe to induce vibration and sound amplification when blowing the mouth piece. A cylindrical protective coating part is formed on the periphery of the connection pipe to implement scratch prevention on a contact part and gap sealing when connecting the connection pipe to the tip coupling part of mouth piece.

Hence, it is still a long felt need to have and use a practice wind instrument (horn, wind controller, MIDI controller, wind instrument, saxophone and the like), especially a training horn which mimic the original instrument, which will be intuitively played, also by non-professional players, be portable, accurate, small and weight. More specifically, a practice music instrument that delivers and reflects the actual feel of the original instruments.

### SUMMARY OF THE INVENTION

It is an object of the invention to disclose a silent digital practice horn, useable with or without a mouthpiece, characterized by a processor and communicating means enabling wireless connection with DAW application via MIDI-USB or Bluetooth modules, and thereby connection with computers or smartphones, speakers or headphones thereof.

It is an object of the invention to disclose a digital practice shortened either Saxophone-like or Clarinet-like horn, wherein one or more of the following is held true: octave key is configured to change range; High E key (Eb-like horn) is configured to shift tonal range up; C key is configured to shift to normal tonal range; Bb key (Bb-like horn) is configured to shift tonal range down; at least one of the following, F key, E/F♯ key and D key is configured to facilitate or change MIDI Channel; Additional F♯ key is configured to power the horn Off; Eb/D3 Key and low C key, when pressed together, enters the processor to a “Command Mode”.

It is an object of the invention to disclose a practice horn that comprises a siphon which causes saliva and moisture to run down a pipe inside the instrument and to drip out of a “Moisture Outlet” in a bottom cap located at the distal most portion of the horn. It is one object of the invention to disclose a silent digital practice horn (EMEO), useable with or without a mouthpiece, characterized by a processor and communicating means enabling wireless connection with DAW application via MIDI-USB or Bluetooth modules, and thereby connection with computers or smartphones, speakers or headphones thereof.

It is an object of the invention to disclose a digital practice shortened either Saxophone-like or Clarinet-like horn (EMEO) as defined above, wherein one or more of the following is held true: octave key is configured to change range; High E key (Eb-like horn) is configured to shift tonal range up; C key is configured to shift to normal tonal range; Bb key (Bb-like horn) is configured to shift tonal range down; at least one of the following, F key, E/F♯ key and D key is configured to facilitate or change MIDI Channel; Additional F♯ key is configured to power the horn Off; Eb/D3 Key and low C key, when pressed together, enters the processor to a “Command Mode”.

It is an object of the invention to disclose a silent digital practice horn (EMEO) as defined in any of the above, wherein said horn comprises a siphon which causes saliva and moisture to run down a pipe inside the instrument and to drip out of a “Moisture Outlet” in a bottom cap located at the distal most portion of the horn.

It is an object of the invention to disclose an operating system configured to process keying and air blowing via the mouthpiece of a silent digital practice horn as defined in any of the above.

It is an object of the invention to disclose an operating system configured to process keying and air blowing via the mouthpiece of digital practice shortened Saxophone-like horn as defined in any of the above.

It is an object of the invention to disclose a kit comprising a silent digital practice horn as defined in any of the above.

It is an object of the invention to disclose a kit comprising a digital practice shortened Saxophone-like horn as defined in any of the above.

It is an object of the invention to disclose silent digital practice horn, useable with or without a mouthpiece, characterized by a processor and communicating means enabling wireless connection with DAW application via MIDI-USB or Bluetooth modules, and thereby connection with computers or smartphones, speakers or headphones thereof, wherein one or more of the following is held true: octave key is configured to change range; High E key (Eb-like horn) is configured to shift tonal range up; C key is configured to shift to normal tonal range; Bb key (Bb-like horn) is configured to shift tonal range down; at least one of the following, F key, E/F♯ key and D key is configured to facilitate or change MIDI Channel; Additional F♯ key is configured to power the horn Off; Eb/D3 Key and low C key, when pressed together, enters the processor to a “Command Mode” and further wherein said horn comprises a siphon which causes saliva and moisture to run down a pipe inside the instrument and to drip out of a “Moisture Outlet” in a bottom cap located at the distal most portion of the horn.

### BRIEF DESCRIPTION OF THE FIGURES AND PHOTOS

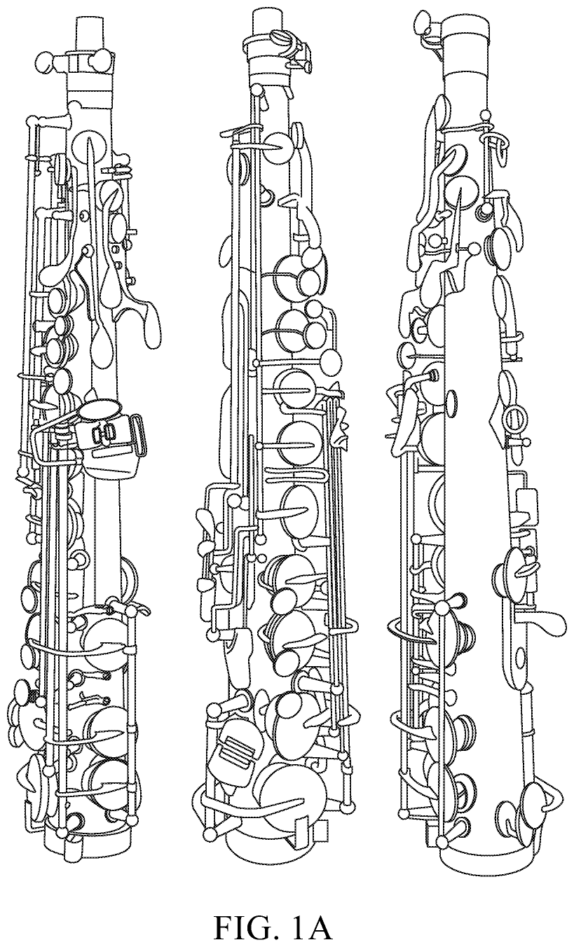

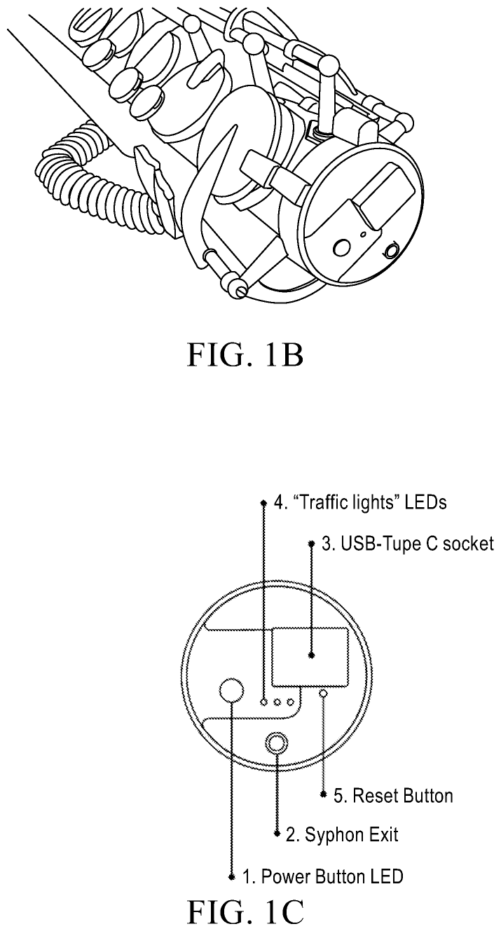

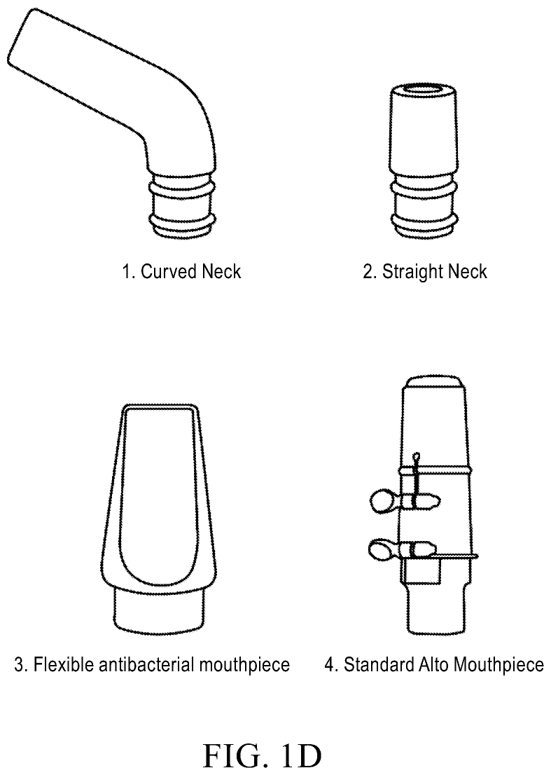

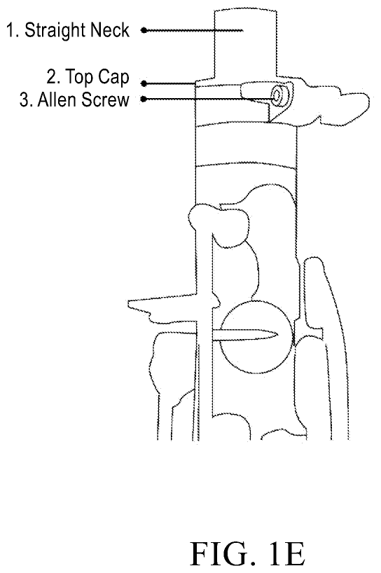

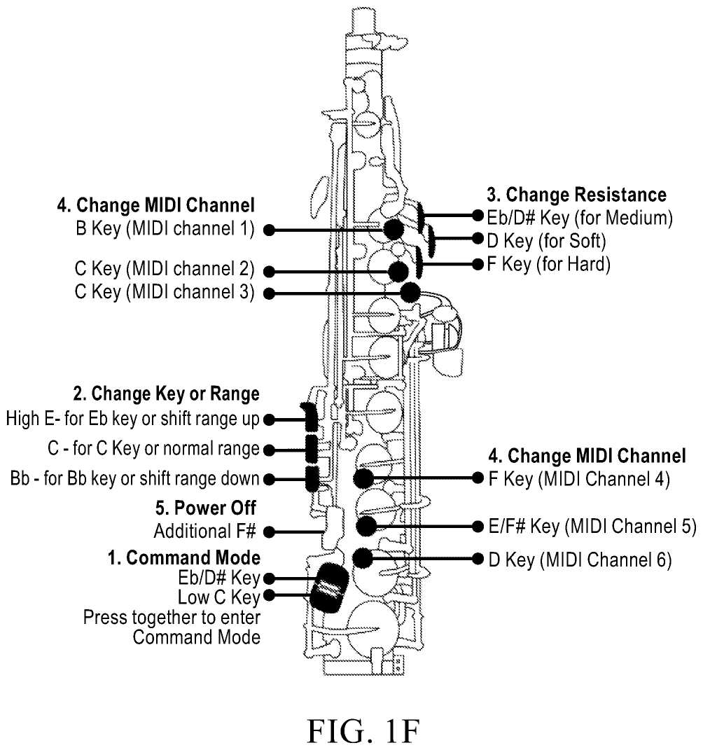

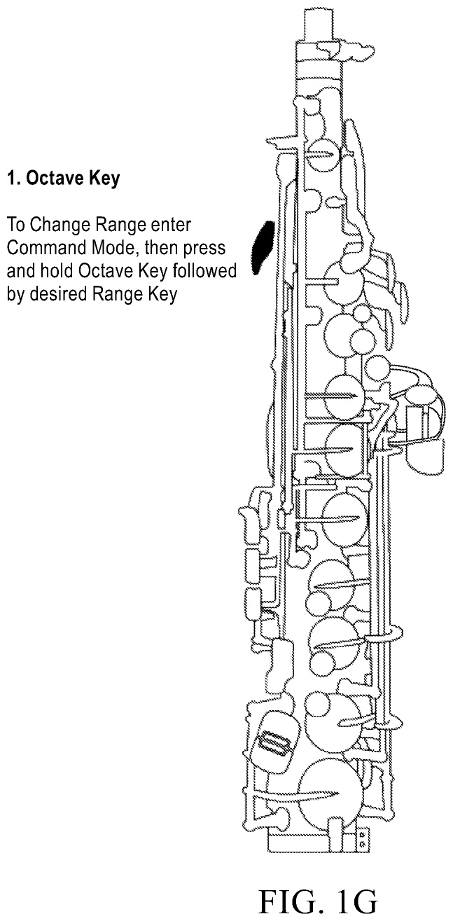

The disclosure will provide details in the following description of one or more embodiments with reference to the following figures and photos. The figures are not necessarily to scale. The figures are merely schematic representations, not intended to portray specific parameters of the one or more embodiments of the invention. The figures are intended to depict only typical embodiments of the invention. In the figures, like numbering represents like elements. The novel features believed characteristic of one or more embodiments of the invention are set forth in the appended claims. The one or more embodiments of the invention itself however, will best be understood by reference to the following detailed description of an illustrative embodiment when read in conjunction with the accompanying drawings, wherein FIGS. 1A-1G are photos and illustrates in various views of the hereto disclosed a practice horn (herein after “EMEO”) according to several embodiments of the invention.

### DETAILED DESCRIPTION OF THE PREFERRED EMBODIMENTS

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is hence the object of the invention to disclosed a practice wind instrument. The terms sax and horn are interchangeably relating to an EMEO instrument, wind controller, MIDI controller, wind horns, wind instruments, saxophones, clarinets and the like. In the following example, an Alto-Saxophone is altered to a modified practice horn. especially a training horn which mimic the original instrument, which will be intuitively played, also by non-professional players, be portable, accurate, small and weight. More specifically, a practice music instrument that delivers and reflects the actual feel of the original instruments.

It is also in the scope of the invention that the hereto defined and presented training instrument is provided useful also in real playing, and not merely for practicing and training. Hence, the horn is useable by professional players, for recording, teaching, providing special effects and so on and so forth.

It is in the scope of the invention where EMEO is available in several different colorways including vintage brown, classic gold and black nickel.

An example of the device and its operating system is disclosed herein in a non-limiting manner. Reference is now made to FIGS. 1A-1G. FIGS. 1a and 1b are photos taken from rear view and bottom view, respectively. FIG. 1C depicts Diagram A, namely EMEO's Bottom Cup; FIG. 1D depicts Diagram B, namely Necks and Mouthpieces; FIG. 1E depicts Diagram C, namely Top portion of EMEO; FIG. 1F depicts Diagram D, namely front portion of EMEO; and FIG. 1G depicts Diagram E, namely Rear portion of EMEO.

e.g., a saxophone alt as an example of a wood instrument (here e.g., a member of the sax music instruments) that altered by adding octave key cup (hereinafter “key”) to the body (from the neck portion of the pre-altered saxophone). The key is replacing two keys of eth pre-altered sax (octave keys). The hereto disclosed sax is shorter and lighter than the original alto sax by having no bell and no bow. As said above, the modified music instruments intuitively played, also by non-professional players, is portable and accurate. More specifically, this practice music instrument delivers and reflects the actual feel of the original instruments.

When the battery is fully charged you will have approximately six hours playing time (via Bluetooth) and the Power Button will be green. When the Power Button begins to slowly flash red, you have one-hour battery left. When charging EMEO, “Main Button” will be red. When EMEO is fully charged it will slowly flash green. It takes approximately three hours to charge EMEO from empty until full, depending what type of power supply you are using. Note that when you play via data cable your EMEO will also charge from your host device. In this case EMEO will take longer to charge, then if it is connected to a charging unit.

Reset the Wind controller sensor. A “Wind Control” sensor inside EMEO is sensitive to changes in surrounding air pressure. If while playing, player notices a change in the responsiveness of EMEO when blowing, it might be due to a change in air pressure. If this is the case, enter “Command Mode” and perform any function to reset the wind control sensor; see FIG. 1D that illustrates in an out of scale manner a front portion of EMEO according to one embodiment of the invention.

It is in the scope of one set of embodiments of the invention to disclose a digital practice horn (EMEO), here a device configured for saxophone players. EMEO is a MIDI wind controller intended to be as close as possible to a conventional saxophone, allowing player to advance his/her playing without limitations. EMEO does not have onboard sounds, and player must use it with a DAW application, such as Imoxplus' product commercially available product Respiro, see currently available link https://www.midi.org/midi-articles/respiro-from-imoxplus, which is included or otherwise communicable with EMEO. It is noted that Imoxplus is a provider of hardware and software for wind & breath controllers. The content of the currently available link https://www.EMEOmusic.com and accompanying videos are incorporated herein as a reference.

It is in the scope of another set of embodiments of the invention to disclose an EMEO kit, e.g., a kit comprises one or more of the following: Protective case, with single and double shoulder straps. USB type C cable for USB-MIDI connection and charging. Neck strap. Conventional alto saxophone mouthpiece. Flexible, antibacterial mouthpiece. Straight neck. Curved neck. Cleaning cloth. Small screwdriver. The purpose of the flexible, antibacterial mouthpiece is to protect teeth while playing in moving vehicles, buses, trains, and airplanes.

It is in the scope of another set of embodiments of the invention to disclose an EMEO kit comprises a battery. E.g., one or more that are partly charged. Player is instructed to charge it up fully, until the Power Button flashes green; see No. 1 in FIG. 1D that illustrates in an out of scale manner a front portion of EMEO according to one embodiment of the invention.

It is possible to play EMEO while it is charging. Player can connect EMEO to a mobile phone, tablet, laptop or desktop computer. EMEO is configured to work with Apple, Windows and Android devices. If EMEO is player's first experience playing a MIDI wind controller, a commercially available Respiro software is useable.

It is in the scope of another set of embodiments of the invention to disclose an EMEO which comprises only one button, namely “Power Button”. The power button is an LED, which is able to change colour, from Green to Red and also to flash, see No. 1 in FIG. 1C depicts EMEO's Bottom Cup and presenting location of the Power Button. EMEO also comprises some three ‘Traffic Light’ LEDs next to the main button, which indicate various functions, such as which key you are playing in, what is the state of the battery, and if players are connected via data cable; see No. 4 see in FIG. 1C. To power on EMEO, Power Button is pressed for four seconds. Nevertheless, in case player connects EMEO to a device via USB Type C data cable, it turns on automatically. When player connects a device via a data cable, traffic lights will show red, amber and green, three times to indicate the connection is made. After some five seconds, traffic lights have finished making their indication and then player is instructed for beginning to play.

As was noted above that player can connect the to desktop computers, laptops, tablets and smartphones via Bluetooth, e.g., using the MIDI-BLE protocol or DAW app, such as Garage Band for Apple and others, which allow player to use MIDI-Bluetooth without the need for additional software.

Playing with different mouthpieces It is in the scope of another set of embodiments of the invention wherein EMEO is compatible with both a standard alto mouthpiece and a special flexible, antibacterial mouthpiece, Nos. 3 and 4 in FIG. 1D

According to player preference, he/she can play EMEO with either of the kit-included mouthpieces, with players own alto mouthpiece and also without any mouthpiece at all, by blowing directly into the top of the instrument. Player can attach and remove mouthpieces in exactly the same way as with a conventional saxophone. EMEO is constructed so that a conventional mouthpiece will not make a noise of its own when you play. A novel feature is that EMEO enables player for playing in a moving vehicle, by using a flexible mouthpiece, to keep teeth safe, see No. 3 in FIG. 1C

Changing Neck It is in the scope of another set of embodiments of the invention wherein EMEO is compatible with a straight neck and a curved neck, see Nos. 1 and 2 see No. 1 in FIG. 1C) Player can switch these according to his/her preference. In order to change necks, it is possible to grip the neck and apply gentle pressure, while turning it, until it pops out. To apply the other neck, gently push it in, while turning it.

Saliva and Moisture It is in the scope of another set of embodiments of the invention to disclose an EMEO which comprises a siphon which causes saliva and moisture to run down a pipe inside the instrument and to drip out of the “Moisture Outlet” in the bottom cap see No. 2 in FIG. 1C) This means all EMEO's electronics are kept totally safe.

Controlling EMEO It is in the scope of another set of embodiments of the invention wherein EMEO has two modes: “Play Mode” and “Command Mode”. player control EMEO's functions, by entering “Command Mode” and pressing various combinations of keys on the instrument. For each action player performs, he/she need to enter “Command Mode” again. To enter “Command Mode”—press both the D♯/Eb and low C keys together with your right hand and blow through the instrument; see No. 1 in FIG. 1D that depicts the front portion of EMEO. Note that none of the traffic lights are lit when player is in “Command Mode”. Note also that when player is in “Command Mode” and he/she accidentally press on the wrong key, player will need to re-enter “Command Mode” to perform the desired function.

Changing Key It is in the scope of another set of embodiments of the invention wherein EMEO allows player to change between keys of C, Bb and Eb, using his/her right hand, see No. 2 in FIG. 1D. To change key, first enter “Command Mode”. To choose key of Eb, press high E key. By doing so, green ‘traffic light’ will lit. The instrument will then be ready to play. To change to key of Bb, enter “Command Mode”, and press Bb key. By doing so, red ‘traffic light’ will lit. To change to key of C, enter “Command Mode” and press central C button. By doing so, the traffic light will lit. Every time player powers on, EMEO will be in key of C as a default.

Changing Range It is in the scope of another set of embodiments of the invention wherein the range of EMEO is similar to a conventional saxophone, except that player can also play low A on EMEO, as with a baritone saxophone. EMEO also allows player to raise or lower the entire range by one octave. To do so, player enters “Command Mode”. Press and hold “Octave Key” with left thumb, and while doing so, choose your desired range, see FIG. 1G that depicts the Rear portion of EMEO No. 1. To shift the entire range one octave up, press E key, see (2) FIG. 1F that depicts the front portion of EMEO. To shift the entire range down by one octave, press Bb key, see (2) FIG. 1F). To move the range back to default range, enter “Command Mode” once again, press and hold octave key, while pressing C key, (2) FIG. 1F. Every time player powers on EMEO, it will be in normal range as a default.

Changing the Resistance of the Wind Controller It is in the scope of another set of embodiments of the invention wherein EMEO has three possible settings: “soft”, “medium” and “hard”. player can make his/her choice, depending upon how sensitive player wishes EMEO to be and to how hard player is blowing. To change the resistance, enter “Command Mode”. With left-hand, press one button of either D: soft Eb/D♯: medium F: hard. (See No. 3 in FIG. 1F) Every time player turns on EMEO, it will be in the “soft” setting as a default.

Playing without blowing. It is in the scope of another set of embodiments of the invention wherein there are two ways to play EMEO without blowing. The first allows player to add dynamics and tongue control, if player do choose to blow. The second option will make EMEO play on a full volume and there will be no option to add dynamic control and tongue control. To play without blowing, but still have an option to add dynamic control and tongue control: enter “Command Mode”, then suck on EMEO and while doing so, choose which key to play in, namely either C, Bb or Eb, (2) FIG. 1F. The instrument will then play without blowing, but will accept dynamic control and tongue control when player chooses to blow. To play without blowing, without the option of adding dynamic control and tongue control: enter Command Mode, blow into EMEO and choose which key you want to play in either C, Bb or Eb (2) FIG. 1F. To exit this mode, enter “Command Mode” (even without blowing) and perform any function.

Switching MIDI channels It is in the scope of another set of embodiments of the invention wherein player can choose between 6 MIDI channels. To switch MIDI channels, enter “Command Mode”, and then press one of the following buttons: B for Channel no. 1; C for Channel no. 2; G for Channel no. 3; F for Channel no. 4; E/F♯ for Channel no. 5; D for Channel no. 6.

Switching off EMEO It is in the scope of another set of embodiments of the invention wherein player enters “Command Mode”, and then press additional F♯ button (5) FIG. 1F. By doing so, player will notice that light on the “Main Button” turns off, see (1) in FIG. 1C that illustrates EMEO's Bottom Cup In this embodiment, EMEO avoids accidentally turning it off during play. Alternatively, after 20 minutes without playing EMEO, it will power itself off.

Battery indication. It is in the scope of another set of embodiments of the invention wherein players power EMEO on, “Traffic Lights” shows for three seconds revealing status of battery. Three light dots show that battery is full (red, amber and green); two lights show battery is half full (red and amber); and single light shows battery is low (red). For location of “Traffic Lights” see (4) in FIG. 1C. While playing, player can also check status of battery by looking at the colour of the “Power Button”. For location of “Power Button” see (1) in FIG. 1C. When battery is fully charged, player will have approximately six hours of playing time (via Bluetooth) and “Power Button” will be green. When “Power Button” begins to slowly flash red, player has one-hour battery left. When charging EMEO—“Main Button” will be red. When EMEO is fully charged, it will slowly flash green. It takes approximately three hours to charge EMEO from empty until full, depending what type of power supply players are using. Note that when player plays via data cable, EMEO will also charge from host device. In this case EMEO will take longer to charge, then if it is connected to a charging unit.

Reset the Wind controller sensor. It is in the scope of another set of embodiments of the invention wherein a Wind Control sensor inside EMEO is sensitive to changes in surrounding air pressure. If while playing, you notice a change in the responsiveness of EMEO when blowing, it might be due to a change in air pressure. If this is the case, enter Command Mode and perform any function to reset the wind control sensor, see (1) in FIG. 1F.

Using Respiro Sounds It is in the scope of another set of embodiments of the invention wherein EMEO is compatible with commercially available Imoxplus products, such as Respiro. Resiro is a sound generator designed to respond optimally to EMEO. It offers a sophisticated, sonic palette of uniquely adjustable timbres, which give an organic and responsive feel.

Performing a hard-reset It is in the scope of another set of embodiments of the invention wherein player uses a screw driver provided in the kit to give a short press of the reset button, see (5) in FIG. 1C. It I noted that if player accidentally presses the reset button twice, he/she will put EMEO into a “Boot Mode”, which is used in maintenance. If EMEO is in “Boot Mode”, the amber light on the traffic lights will flash. To exit “Boot Mode,” press reset button one more short time.

How to lay it down. It is in the scope of another set of embodiments of the invention wherein player, currently is not using his/her EMEO, placing it in its case. If player wishes to lay EMEO down, he/she places it face down on a flat surface as this will protect the mechanism.

The term “about” refers herein after to a measure being lower than or greater than up to 25% of the defined measure.

Reference is made again to the three photos depicted in FIG. 1A, presenting the EMEO in its various sides. It is notable that the location of the collar (strap) for keeping the balance of the sax weight is changed, in respect to regular sousaphones. Photos of FIG. 1A also present the change of the place (location) of the thumb rest (holding hook), and showing a caliber aside. Photos of FIG. 1A also present holding hook. three keys that were the location was changed from the bell to the body. The aforesaid keys are B, B flat and C sharp according to this embodiment of the invention. B, B flat and C sharp keys with their arms are also presented. A new location of C and D sharp is further depicted. It is acknowledged in this respect that both bell and sax's concaved neck (bow) are not existing at the hereto invented sax. Hence, C and D sharp moved from bow to body. The figure also sows the key guard according to this embodiment of the invention. Both C and D sharp keys and arms are shown. It is acknowledged in this respect that modifications are merely at right-hand portion of the EMEO and not within its left-hand portion (as compared with regular saxophone. The right-hand portion of the sax after the alternations is also shown. The right-hand portion was changed it location (upwardly, e.g. in this example about 60 mm) to allow the whole keys mechanism be useful in such a shortened sax and to provide a platform for the electronics according to this embodiment of the invention. The modifications herein shown are merely an example that configured to suit an alto-sax-based training EMEO. Other instruments will require equivalent modifications. Keys B flat, C and E (high) in their new location (as compared with regular saxophone) at right-hand portion of the sax. F sharp (high) & F sharp (trill) bifunctional single key is shown.

The hereto presented EMEO comprises a flexible PCB inside the body. PCB and its connector is protruding the surface of the PCB. A hole sensor is utilizable. The sensor is e.g., a magnetic unipolar switch according to this embodiment of the invention.

In the original sax, a plurality of apertures provided the change of tunes. In the EMEO, magnets are used to activate the sensors so the “look and feel” of the “regular” “playing is kept: in a way that the air flow (embouchure) and playing technique reflects the music accurately. Transposition is provided useful in the practicing horn by a set of predefined combinations of the keys and the blow therein. The fingering (aplicatur) of the original instrument is kept in this practice sax.

It is according to an embodiment of the invention wherein original mouth piece of the original horn is utilizable in this training horn, alternatively, the practicing horn can be played without a mouth piece.

It is according to an embodiment of the invention wherein bottom of the EMEO may comprises control LED and USB for connecting and charging according to this embodiment of the invention.

It is according to an embodiment of the invention wherein wind controller and Li-type battery installed with PCB according to this embodiment of the invention.

It is according to an embodiment of the invention wherein a siphon of the wind controller is interconnected or accommodated in the EMEO. The siphon drains/purges/condensates water outside the controller,

It is according to an embodiment of the invention wherein pads are associated with neodymium-type magnets or any other effective magnets. Left-wise is a key according to this embodiment of the invention.

A lower ring for securing the bottom lead is provided. It also guards lower C and D sharp according to this embodiment of the invention.

While there have been shown and described and pointed out the fundamental novel features of the invention as applied to a preferred embodiment, it will be understood that various omissions and substitutions and changes in the form and details of the device illustrated and, in its operation, may be made by those skilled in the art, without departing from the spirit of the invention. It is the intention, therefore, to be limited only as indicated by the scope of the following claims.

1-10. (canceled)

11. A silent digital practice horn, useable with or without a mouthpiece, characterized by a processor and communicating means enabling wireless connection with DAW application via MIDI-USB or Bluetooth modules, and thereby connection with computers or smartphones, speakers or headphones thereof; wherein said horn comprises a newly added single octave key cup, located at the body portion of the horn replaces two octave keys consist in the neck portion of a pre-altered horn; and further wherein said horn consists no bell nor bow sections of a pre-altered horn, thereby is shorten than said pre-altered horn, so that space between keys is narrower, yet even that the dimensions of the horn are altered, the horn is intuitively played accurately.

12. A digital practice shortened either Saxophone-like or Clarinet-like horn of claim 11, wherein one or more of the following is held true: octave key is configured to change range; High E key (Eb-like horn) is configured to shift tonal range up; C key is configured to shift to normal tonal range; Bb key (Bb-like horn) is configured to shift tonal range down; at least one of the following, F key, E/F♯ key and D key is configured to facilitate or change MIDI Channel; Additional F♯ key is configured to power the horn Off; Eb/D3 Key and low C key, when pressed together, enters the processor to a “Command Mode”.

13. The silent digital practice horn of claim 11, wherein said horn comprises a siphon which causes saliva and moisture to run down a pipe inside the instrument and to drip out of a “Moisture Outlet” in a bottom cap located at the distal most portion of the horn.

14. An operating system configured to process keying and air blowing via the mouthpiece of a silent digital practice horn of claim 11.

15. An operating system configured to process keying and air blowing via the mouthpiece of a digital practice shortened Saxophone-like horn of claim 12.

16. An operating system configured to process keying and air blowing via the mouthpiece of a silent digital practice horn of claim 13.

17. A kit comprising a silent digital practice horn of claim 11.

18. A kit comprising a digital practice shortened Saxophone-like horn of claim 12.

19. A kit comprising a silent digital practice horn of claim 13.

20. A silent digital practice horn of claim 11, useable with or without a mouthpiece, characterized by a processor and communicating means enabling wireless connection with DAW application via MIDI-USB or Bluetooth modules, and thereby connection with computers or smartphones, speakers or headphones thereof, wherein one or more of the following is held true: octave key is configured to change range; High E key (Eb-like horn) is configured to shift tonal range up; C key is configured to shift to normal tonal range; Bb key (Bb-like horn) is configured to shift tonal range down; at least one of the following, F key, E/F♯ key and D key is configured to facilitate or change MIDI Channel; Additional F♯ key is configured to power the horn Off; Eb/D3 Key and low C key, when pressed together, enters the processor to a “Command Mode” and further wherein said horn comprises a siphon which causes saliva and moisture to run down a pipe inside the instrument and to drip out of a “Moisture Outlet” in a bottom cap located at the distal most portion of the horn.
